(19) United States
(12) Patent Application Publication
(10) Pub. No.: US 2006/0125734 A1
(43) Pub. Date: Jun. 15, 2006

(54) OLED display with aging compensation

(75) Inventors: Ronald S. Cok, Rochester, NY (US); Felipe A. Leon, Rochester, NY (US)

Correspondence Address: Eastman Kodak Company;Patent Legal Staff, 343 State Street, Rochester, NY, 14650-2201, US

(73) Assignee: Eastman Kodak Company

(21) Appl. No.: 11/008,737

(22) Filed: Dec. 9, 2004

(51) Int. Cl. G09G 3/30

(52) U.S. Cl. 345/76

(57) ABSTRACT

An OLED display, comprising: a) a substrate; b) a plurality of independently controlled light emitting elements formed on the substrate, the light emitting elements having an output that changes with time or use; c) a plurality of active-matrix circuits formed on the substrate for driving the light-emitting elements wherein the performance of some portion of the active matrix circuitry is altered in response to incident radiation, and wherein an incident light absorbing or reflecting layer prevents light from irradiating the portion responsive to incident radiation; d) a current measuring device for sensing the total current used by the display to produce a current signal; and e) a controller responsive to the current signal for calculating a correction signal for the light emitting elements and applying the correction signal to input image signals to produce corrected input image signals that compensate for the changes in the output of the light emitting elements.

### FIELD OF THE INVENTION

The present invention relates to solid-state OLED flat-panel display devices and more particularly to such display devices having means to compensate for the aging of the organic light emitting display.

### BACKGROUND OF THE INVENTION

Solid-state organic light emitting diode (OLED) image display devices are of great interest as a superior flat-panel display technology. These displays utilize current passing through thin films of organic material to generate light. The color of light emitted and the efficiency of the energy conversion from current to light are determined by the composition of the organic thin-film material. Different organic materials emit different colors of light. However, as the display is used, the organic materials in the device age and become less efficient at emitting light. This reduces the lifetime of the display. Different organic materials may age at different rates, causing differential color aging and a display whose white point varies as the display is used.

Referring to FIG. 5, a graph illustrating the typical light output of an OLED display device as current is passed through the OLEDs is shown. The three curves represent typical performance of the different light emitters emitting differently colored light (e.g. R,G,B representing red, green and blue light emitters, respectively) as represented by luminance output over time or cumulative current. As can be seen by the curves, the decay in luminance between the differently colored light emitters can be different. The differences can be due to different aging characteristics of materials used in the differently colored light emitters, or due to different usages of the differently colored light emitters. Hence, in conventional use, with no aging correction, the display will become less bright, the color will change and, in particular, the white point, of the display will shift.

The rate at which the display ages is related to the amount of current that passes through the device and, hence, the amount of light that has been emitted from the display. One technique to compensate for this aging effect in polymer light emitting diodes is described in U.S. Pat. No. 6,456,016 issued Sep. 24, 2002 to Sundahl et al. This approach relies on a controlled reduction of current provided at an early stage of device use followed by a second stage in which the display output is gradually decreased. This solution requires that the operating time of the device be tracked by a timer within the controller. The controller then provides a compensating amount of current. In this approach, once a display has been in use, the controller must remain associated with that display to avoid errors in device operating time. Moreover, the time of use of the display must be accumulated, requiring timing, calculation, and storage circuitry in the controller. Also, this technique does not accommodate differences in behavior of the display at varying levels of brightness and temperature and cannot accommodate differential aging rates of the different organic materials.

U.S. Pat. No. 6,414,661 B1 issued Jul. 2, 2002 to Shen et al. describes a method and associated system that compensates for long-term variations in the light-emitting efficiency of individual organic light emitting diodes (OLEDs) in an OLED display device, by calculating and predicting the decay in light output efficiency of each pixel based on the accumulated drive current applied to the pixel and derives a correction coefficient that is applied to the next drive current for each pixel. This technique requires the measurement and accumulation of drive current applied to each pixel, requiring a stored memory that must be continuously updated as the display is used, requiring complex and extensive circuitry.

US Patent Application 2002/0167474 A1 by Everitt, published Nov. 14, 2002, describes a pulse width modulation driver for an organic light emitting diode display. One embodiment of a video display comprises a voltage driver for providing a selected voltage to drive an organic light emitting diode in a video display. The voltage driver may receive voltage information from a correction table that accounts for aging, column resistance, row resistance, and other diode characteristics. In one embodiment of the invention, correction tables are calculated prior to and/or during normal circuit operation. The correction scheme is based on sending a known current through the OLED diode for a duration sufficiently long to allow the transients to settle out and then measuring the corresponding voltage with an analog to digital converter (A/D) residing on the column driver. A calibration current source and the A/D can be switched to any column through a switching matrix. This design requires the use of integrated, calibrated current sources and an A/D converter, greatly increasing the complexity of the circuit design.

U.S. Pat. No. 6,504,565 B1 issued Jan. 7, 2003 to Narita et al., describes a light-emitting device which includes a light-emitting element array formed by arranging a plurality of light-emitting elements, a driving unit for driving the light-emitting element array to emit light from each of the light-emitting elements, a memory unit for storing the number of light emissions for each light-emitting element of the light-emitting element array, and a control unit for controlling the driving unit based on the information stored in the memory unit so that the amount of light emitted from each light-emitting element is held constant. An exposure device employing the light-emitting device, and an image forming apparatus employing the exposure device are also disclosed. This design requires the use of a calculation unit responsive to each signal sent to each pixel to record usage, greatly increasing the complexity of the circuit design.

JP 2002278514 A by Numeo Koji, published Sep. 27, 2002, describes a method in which a prescribed voltage is applied to organic EL elements by a current-measuring circuit and the current flows are measured; and a temperature measurement circuit estimates the temperature of the organic EL elements. A comparison is made with the voltage value applied to the elements, the flow of current values and the estimated temperature, the changes due to aging of similarly constituted elements determined beforehand, the changes due to aging in the current-luminance characteristics and the temperature at the time of the characteristics measurements for estimating the current-luminance characteristics of the elements. Then, the total sum of the amount of currents being supplied to the elements in the interval during which display data are displayed, is changed so as to obtain the luminance that is to be originally displayed, based on the estimated values of the current-luminance characteristics, the values of the current flowing in the elements, and the display data.

This design presumes a predictable relative use of pixels and does not accommodate differences in actual usage of groups of pixels or of individual pixels. Hence, accurate correction for color or spatial groups is likely to be inaccurate over time. Moreover, the integration of temperature and multiple current sensing circuits within the display is required. This integration is complex, reduces manufacturing yields, and takes up space within the display.

Commonly assigned US2004/0150590 describes an OLED display that includes a plurality of light emitting elements divided into two or more groups, the light emitting elements having an output that changes with time or use; a current measuring device for sensing the total current used by the display to produce a current signal; and a controller for simultaneously activating all of the light emitting elements in a group and responsive to the current signal for calculating a correction signal for the light emitting elements in the group and applying the correction signal to input image signals to produce corrected input image signals that compensate for the changes in the output of the light emitting elements of the group. However, applicant has determined that the current drawn by an active-matrix OLED device may vary with the ambient radiation incident on the device and with the temperature of the OLED device. Hence, a simple measurement of the current consumed by the OLED device may not be sufficient to accurately compensate for changes in OLED material characteristics.

There is a need therefore for an improved active-matrix organic light emitting diode display with aging compensation.

### SUMMARY OF THE INVENTION

In accordance with one embodiment, the invention is directed towards an OLED display, comprising: a) a substrate; b) a plurality of independently controlled light emitting elements formed on the substrate, the light emitting elements having an output that changes with time or use; c) a plurality of active-matrix circuits formed on the substrate for driving the light-emitting elements wherein the performance of some portion of the active matrix circuitry is altered in response to incident radiation, and wherein an incident light absorbing or reflecting layer prevents light from irradiating the portion responsive to incident radiation; d) a current measuring device for sensing the total current used by the display to produce a current signal; and e) a controller responsive to the current signal for calculating a correction signal for the light emitting elements and applying the correction signal to input image signals to produce corrected input image signals that compensate for the changes in the output of the light emitting elements.

### ADVANTAGES

The advantages of this invention are an OLED display device that compensates for the aging of the organic materials in the display without requiring extensive or complex circuitry for accumulating a continuous measurement of display light emitting element use or time of operation.

### BRIEF DESCRIPTION OF THE DRAWINGS

FIG. 1 is a schematic diagram of an OLED display according to one embodiment of the present invention;

FIG. 2 is a cross section of one embodiment of the present invention;

FIG. 3 is a cross section of one embodiment of the present invention;

FIG. 4 is a cross section of an alternative embodiment of the present invention;

FIG. 5 is a graph illustrating the change in light output with respect to cumulative current of an OLED device; and

FIG. 6 is a circuit diagram illustrating a prior art OLED pixel circuit.

### DETAILED DESCRIPTION OF THE INVENTION

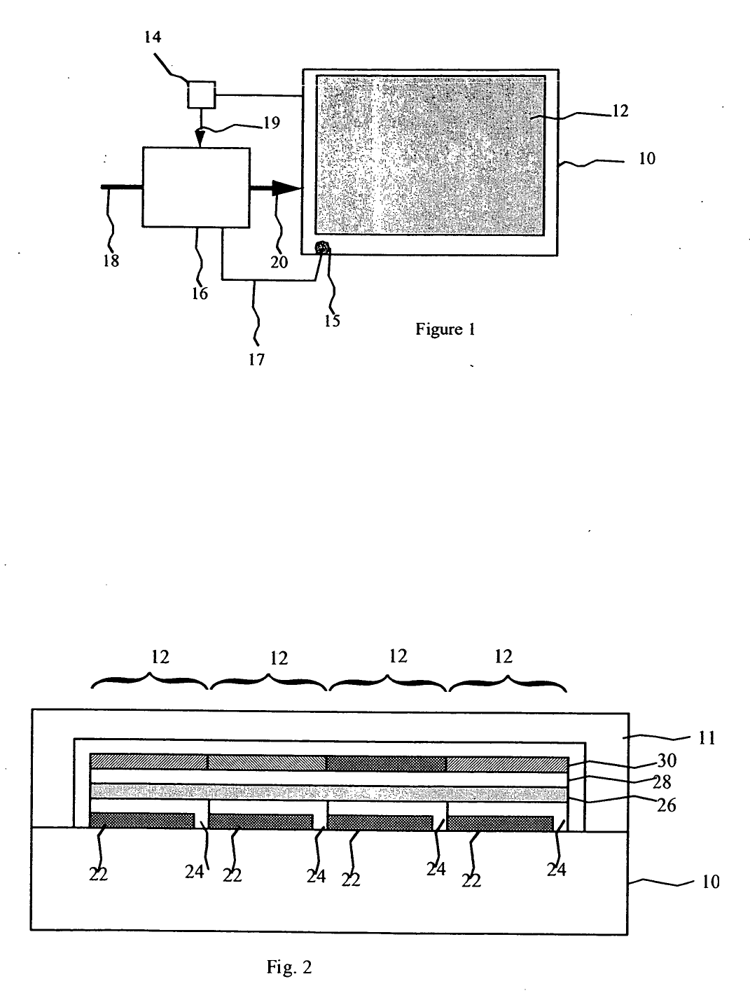

Referring to FIG. 1, one embodiment of the present invention includes an OLED display having a substrate 10; a plurality of independently controlled light-emitting elements 12 formed on the substrate that emit light through color filters to produce a color OLED display device, the light-emitting elements having an output that changes with time or use; a plurality of active-matrix circuits formed on the substrate for driving the light-emitting elements wherein the performance of some portion of the active-matrix circuitry is responsive to incident radiation and wherein an incident light absorbing or reflecting layer prevents light from irradiating the portion responsive to incident radiation; and a current measuring device 14 for sensing the total current used by the display to produce a current signal 19; and a controller 16 responsive to the current signal 19 for calculating a correction for the light emitting elements and applying the correction to input image signals 18 to produce corrected input image signals 20 that compensate for the changes in the output of the light emitting elements. The light emitted may be white light or colored light. If colored light is emitted, the color filters may preferably transmit the color of light emitted.

In a further embodiment of the present invention, a temperature measuring device 15 senses the temperature of the OLED display to produce a temperature signal 17, and the controller is responsive to the temperature signal 17 as well as to the current signal 19.

Active-matrix pixel-driving circuits on flat-panel displays are typically made of thin-film silicon materials, for example amorphous, low-temperature, or micro-crystalline silicon deposited on the flat-panel substrate. Applicants have determined through experimentation that the performance of such thin film silicon materials and at least some portion of the pixel driving circuits they comprise is altered in response to light incident on the circuit. Typically, the incidence of the light on the responsive portions of the circuit causes the circuit to pass more current through the OLED device, thereby increasing its brightness and the current it consumes. Applicants have demonstrated that thin film transistors of the type used for driving OLEDs in prior art circuits may be responsive to a wide spectrum of electromagnetic radiation, including radiation with frequencies ranging from, e.g., infrared to ultraviolet. The incident light absorbing or reflecting layer need not be perfectly absorbing or reflecting so as to prevent all incident light from reaching the pixel driving circuits, and may allow some light to pass through the layer, preferably less than 50% of radiation to which the portion is responsive. In preferred embodiments, the incident light absorbing or reflecting layer accordingly absorbs or reflects at least 50% of radiation to which the portion is responsive.

Portions of active-matrix circuitry in OLED devices typically may be exposed to ambient light or to light emitted by the OLED device itself. In either case, if a portion of the circuit that is responsive to incident light is exposed it will cause the pixel driving circuitry to drive the OLED incorrectly, thereby causing a false reading of current usage. To correct for this, an incident light absorbing or reflecting layer covers the responsive portion of the pixel-driving circuit, thereby preventing light from irradiating the circuit and altering the light output and causing false readings. For a top-emitting OLED device, the incident light absorbing or reflecting layer is located between the responsive portion of circuitry and the cover; for a bottom-emitting OLED device, the incident light absorbing or reflecting layer is located between the responsive portion of the circuitry and the substrate. The light absorbing or reflecting layer prevents at least some of the incident light to which the portion is responsive. Suitable layers may include, for example, reflective or light absorbing metal layers capable of absorbing or reflecting light of any or all wavelengths within the ultraviolet, visible, and infrared regions. Such layers may comprise electrodes or heat-spreading layers, or layers of filter elements, for example color filters comprising dyes or pigments, or black matrix materials such as carbon black, metal oxides, or other materials known in the art.

Referring to FIG. 2, a cross-section of one embodiment of the present invention is shown. In FIG. 2, active-matrix circuits 22 are formed on the substrate 10 and a reflective electrode 24 is formed on the substrate and over an associated active-matrix circuit 22 that drives the light-emitting element associated with the reflective electrode 24. One or more layers of organic material 26 comprising an OLED are deposited over the reflective electrode 24. Means for forming such layers are known in the art. A second, transparent electrode 28 is formed over the layers of organic material 26. The construction and operation of OLED devices is well known in the art.

In one embodiment, a plurality of color filters 30 are formed over the second electrode 28 and patterned to complement independently controlled white light-emitting elements 12, thereby filtering the emitted white light to enable a color display. Color filters, for example red, green, and blue, suitable for this application are well known in the LCD art. In this embodiment, the reflective electrodes prevent any ambient radiation from exposing the responsive portions of the active-matrix circuitry and light is emitted from the display through the cover 11.

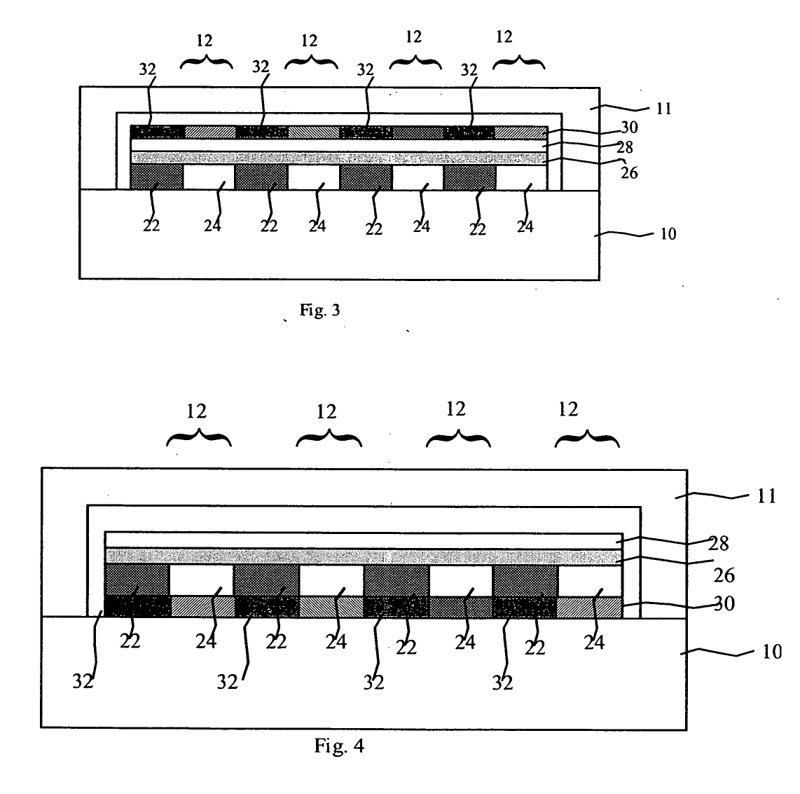

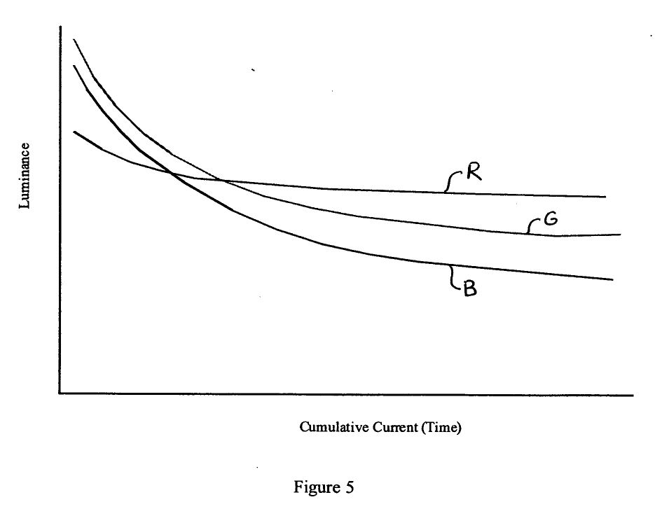

Referring to FIG. 3, a cross-section of an alternative embodiment of the present invention is shown. In FIG. 3, active-matrix circuits 22 are also formed on the substrate 10 but the reflective electrode 24 is not formed over an associated active-matrix circuit 22. One or more layers of organic material 26 comprising an OLED are deposited over the reflective electrode 24. A second, transparent electrode 28 is formed over the layers of organic material 26. A color filter 30 is formed over the second electrode 28 and patterned to complement the independently controlled light-emitting elements 12. However, an additional color filter 32 is formed over the responsive portions of the active-matrix circuitry. In this embodiment, the additional color filters 32 prevent at least some ambient radiation from exposing the active-matrix circuitry. The color filters 32 may be formed of material used to form a black matrix or may be conventional color filters deposited on top of each other, for example red, green, and/or blue filters, to absorb all or most of the incident ambient radiation. In this embodiment, light is emitted from the display through the cover 11.

Referring to FIG. 4, a cross-section of another alternative embodiment of the present invention is shown. In FIG. 4, active-matrix circuits 22 are also formed on the substrate 10 but the electrode 24 is transparent and formed only on the substrate and not over an associated active-matrix circuit 22. One or more layers of organic material 26 comprising an OLED are deposited over the reflective electrode 24. A second, reflective electrode 28 is formed over the layers of organic material 26. A color filter 30 is formed between the transparent electrode 24 and the substrate and patterned to complement the independently controlled light-emitting elements 12. Alternatively, the color filters 30 and 32 may be located on the other side of the substrate 10. In this embodiment, light is emitted through the substrate 10 and the additional color filters 32 prevent any ambient radiation from exposing the active-matrix circuitry. The color filters 32 may be formed of material used to form a black matrix or may be conventional color filters deposited on top of each other, for example red, green, and/or blue filters, to absorb all or most of the incident ambient radiation.

In a preferred embodiment, the present invention is employed in a top-emitting arrangement with a reflective anode located over the light responsive portions of the active-matrix circuit that drives each pixel element. Top-emitting architectures are employed to increase the light-emitting area over the substrate of an OLED device by locating some elements of the circuitry, including busses, capacitors, signal lines, and thin-film transistors. However, layouts created by applicant demonstrates that, although top-emitter designs do have an increased light-emitting area in comparison to bottom-emitting designs, by no means all of the area can be light emitting. In general, fill factors (proportion of area from which light is emitted) of 45% to 70% can be expected while fill factors below 45% are found with bottom-emitting designs. Because of this limitation, it is important to cover the portions of the pixel circuits that are responsive to light and cause more current to pass through the OLED elements. Other portions may be exposed to ambient light or the light emitted by the OLED itself.

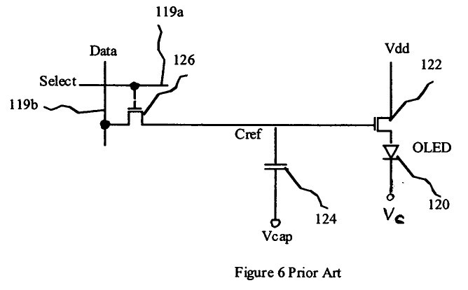

Active matrix pixel driving circuits generally comprise a deposition and storage portion and a driving portion. Typically, while the deposition and storage portion may be somewhat responsive, the portion of the circuit most responsive to light in causing more current to pass through the OLED elements is the driving portion. For example, in one prior-art circuit shown in FIG. 6, the transistor 122 in series with the OLED element 120 between the Vdd and Vc signal drives the OLED element 120 and may be responsive to incident light, such that incident light may alter the current passing through the OLED element 120. In this case, the driving portion of the pixel circuit, i.e., transistor 122, should be located behind the incident light absorbing or reflecting layer. Other circuit elements such as the storage portion (capacitor 124) and the deposition portion (control transistor 126), the signal lines 119a and 119b and any bus lines (not shown) may be exposed to light or may also be located behind the incident light absorbing or reflecting layer. While the circuit shown in FIG. 6 may be employed with the present invention, other circuit designs known in the art may also be employed, for example circuits responsive to a voltage signal or to a current signal and may employ, for example, current mirror circuits or other circuit designs. In these cases, a portion of the active-matrix circuit responsive to light for driving the OLED element may be located beneath the incident light absorbing or reflecting layer.

In an alternative embodiment of the present invention, different OLED materials are employed for different pixels to emit differently colored light. OLED materials that emit different colors of light are well known and commercially practiced, for example in the Kodak LS633 digital camera. In this embodiment, the means described above may also be employed, for example reflective electrodes, metal heat spreading layers, black matrix materials, or color filters. If the color filters are employed over the light emitting elements as well as the responsive portions of the active matrix circuitry, the color filter used over each light emitting element should transmit the same color of light as is emitted by the light emitting element. The use of such color filters over the light emitting elements can improve the ambient contrast of the display by absorbing ambient light without substantially reducing the amount of light emitted by the light emitting elements.

The current measuring device 14 can comprise, for example, a resistor connected across the terminals of an operational amplifier as is known in the art. The controller 16 may comprise a digital or analog control circuit using integrated circuit technology well known in the semiconductor art.

In one embodiment, the display is a color-image display comprising an array of pixels, each pixel including a plurality of different colored light emitting elements (e.g. red, green and blue) 12 that are individually controlled by the controller circuit 16 to display a color image. The colored light emitting elements may be formed by the same organic white light emitting materials. In another embodiment, the light emitting elements are individual graphic elements within a display and may not be organized as an array.

The aging of the OLEDs is related to the cumulative current passed through the OLED resulting in reduced performance; also, the aging of the OLED material results in an increase in the apparent resistance of the OLED that causes a decrease in the current passing through the OLED at a given voltage. This change in current is directly related to the decrease in luminance of the OLED at a given voltage. In addition to the OLED resistance changing with use, the light emitting efficiency of the organic materials is reduced. The decrease in performance is also related to the temperature at which the device is operated: the higher the temperature, the worse the material degradation. Applicants have also determined through experimentation that the at least some portions of the active-matrix circuitry employed in OLED devices are very sensitive to ambient illumination and to temperature. As the light incident on the active-matrix circuits or the temperature increases, the current through the OLED likewise increases and the light emitted by the OLEDs increases. Hence, any measurement of the current used by the OLED devices must correct for these confounding factors by correcting the luminance-to-current relationship.

The present invention operates as follows. When a display device having active-matrix circuitry that is not exposed to ambient or emitted radiation according to the present invention is put into service, the controller measures the current used by the device for a known signal and, optionally, measures the temperature of the device. These measurements are combined to provide a corrected current value. The corrected current value is related to the decrease in efficiency of the OLED device for the known signal. The measure of decrease in efficiency of the OLED device is used to construct a correction transformation that is employed by the controller to correct an unknown input signal to form a corrected input signal used to drive the display device. US2004/0150590 describes such measurements and corrections in more detail, the disclosure of which is incorporated herein by reference. Because the active-matrix circuitry is not exposed to incident ambient radiation, it does not contribute to the current measured.

The temperature measurement device may be a sensor external to the substrate but affixed to it, or it may be a sensor integrated on the substrate. For example, a thermocouple placed on the substrate of cover of the device may be employed or a temperature sensing element, such as a thermistor, may be integrated into the electronics of the display.

Over time the OLED materials will age, the resistance to current flow of the OLEDs increases, the current used at the given input image signal will decrease and the correction signal will increase. At some point in time, the controller circuit 16 will no longer be able to provide an image signal correction that is large enough and the display will have reached the end of its lifetime and can no longer meet its brightness or color specification. However, the display will continue to operate as its performance declines, thus providing a graceful degradation. Moreover, the time at which the display can no longer meet its specification can be signaled to a user of the display when a maximum correction is calculated, providing useful feedback on the performance of the display.

The present invention can be constructed simply, requiring only (in addition to a conventional display controller) a current measurement circuit, a transformation means for the model to perform the image signal correction (for example a lookup table or amplifier), and a calculation circuit to determine the correction for the given image signal. No current accumulation or time information is necessary. Corrections may be calculated periodically or at predefined times such as power-up or power-down.

The corrected image signal may take a variety of forms depending on the OLED display device. For example, if analog voltage levels are used to specify the image signal, the correction will modify the voltages of the image signal. This can be done using amplifiers as is known in the art. In a second example, if digital values are used, for example corresponding to a charge deposited at an active-matrix light emitting element location, a lookup table may be used to convert the digital value to another digital value as is well known in the art. In a typical OLED display device, either digital or analog video signals are used to drive the display. The actual OLED may be either voltage- or current-driven depending on the circuit used to pass current through the OLED. Again, these techniques are well known in the art.

The correction signals used to modify the input image signal to form a corrected image signal may be used to implement a wide variety of display performance attributes over time. For example, the model used to supply correction signals to an input image signal may hold the average luminance or white point of the display constant. Alternatively, the correction signals used to create the corrected image signal may allow the average luminance to degrade more slowly than it would otherwise due to aging. Additionally, the correction signals may be used to correct for differential color aging in cooperation with controlled luminance degradation to optimize the performance of the OLED device.

In a preferred embodiment, the invention is employed in a device that includes Organic Light Emitting Diodes (OLEDs) which are composed of small molecule or polymeric OLEDs as disclosed in but not limited to U.S. Pat. No. 4,769,292, issued Sep. 6, 1988 to Tang et al., and U.S. Pat. No. 5,061,569, issued Oct. 29, 1991 to VanSlyke et al. Many combinations and variations of organic light emitting displays can be used to fabricate such a device, including active- or passive-matrix controlled OLED devices and top- or bottom-emitting OLED devices.

The invention has been described in detail with particular reference to certain preferred embodiments thereof, but it will be understood that variations and modifications can be effected within the spirit and scope of the invention.

### PARTS LIST

10 substrate
11 cover
12 light emitting elements
14 current measuring device
15 temperature sensor
16 controller
17 temperature signal
18 input image signal
19 current signal
20 corrected input image signal
22 active-matrix circuitry
24 electrode
26 organic material layers
28 electrode
30 color filters
32 black color filter
119a, 119b signal lines
120 OLED element
122 driving transistor
124 capacitor
126 control transistor

1. An OLED display, comprising:
a) a substrate;
b) a plurality of independently controlled light emitting elements formed on the substrate, the light emitting elements having an output that changes with time or use;
c) a plurality of active-matrix circuits formed on the substrate for driving the light-emitting elements wherein the performance of some portion of the active matrix circuitry is altered in response to incident radiation, and wherein an incident light absorbing or reflecting layer prevents light from irradiating the portion responsive to incident radiation;
d) a current measuring device for sensing the total current used by the display to produce a current signal; and
e) a controller responsive to the current signal for calculating a correction signal for the light emitting elements and applying the correction signal to input image signals to produce corrected input image signals that compensate for the changes in the output of the light emitting elements.

2. The OLED display of claim 1, wherein the incident light absorbing or reflecting layer prevents ambient light from irradiating the portion responsive to incident radiation.

3. The OLED display of claim 1, wherein the incident light absorbing or reflecting layer prevents light emitted by the OLED display from irradiating the portion responsive to incident radiation.

4. The OLED display claimed in claim 1, wherein a reflective electrode prevents light from irradiating the portion responsive to incident radiation.

5. The OLED display claimed in claim 1, wherein a heat-spreading metal layer prevents light from irradiating the portion responsive to incident radiation.

6. The OLED display claimed in claim 1, wherein the incident light absorbing or reflecting layer comprises color filters that prevent light from irradiating the portion responsive to incident radiation.

7. The OLED display claimed in claim 1, wherein the incident light absorbing or reflecting layer comprises a black matrix that prevents light from irradiating the portion responsive to incident radiation.

8. The OLED display claimed in claim 1, wherein the black matrix comprises a metal oxide.

9. The OLED display claimed in claim 1, wherein the black matrix comprises carbon black.

10. The OLED display claimed in claim 1, wherein the light emitting elements emit white light and wherein color filters are employed to filter the light and form a color display.

11. The OLED display claimed in claim 10, wherein a separate color filter is employed to prevent light from irradiating the portion responsive to incident radiation.

12. The OLED display claimed in claim 10, wherein a combination of color filters employed to filter the light and form a color display are positioned to prevent light from irradiating the portion responsive to incident radiation.

13. The OLED display of claim 1, further comprising a temperature measuring device for sensing the temperature of the OLED display to produce a temperature signal and wherein the controller is responsive to the temperature signal.

14. The OLED display claimed in claim 13, wherein the temperature measuring device is external to the substrate.

15. The OLED display claimed in claim 14, wherein the temperature measuring device is integrated on the substrate.

16. The OLED display claimed in claim 1, wherein the light emitting elements emit colored light.

17. The OLED display claimed in claim 1, wherein the active-matrix circuit comprises a deposition and storage portion and a driving portion, and the portion of the active-matrix circuit responsive to radiation is the driving portion.

18. The OLED display claimed in claim 1, wherein the incident light absorbing or reflecting layer absorbs or reflects at least 50% of radiation to which the portion is responsive.

19. The OLED display claimed in claim 1, wherein the incident light absorbing or reflecting layer absorbs or reflects at least 50% of radiation of any wavelength within the ultraviolet, visible, and infrared regions.

20. A method of driving an OLED display, comprising:
a) forming a plurality of independently controlled OLED light emitting elements on a substrate, the light emitting elements having an output that changes with time or use;
b) forming a plurality of active-matrix circuits on the substrate for driving the light-emitting elements wherein the performance of some portion of the active matrix circuitry is altered in response to incident radiation, and providing an incident light absorbing or reflecting layer to prevent light from irradiating the portion responsive to incident radiation;
c) measuring the total current used by the display and producing a current signal;
d) employing a controller responsive to the current signal to calculate a correction signal for the light emitting elements and to apply the correction signal to input image signals to produce corrected input image signals that compensate for the changes in the output of the light emitting elements; and
e) driving the light emitting elements with the corrected input image signals.
